(19) United States
(12) Patent Application Publication
(10) Pub. No.: US 2009/0260267 A1
(43) Pub. Date: Oct. 22, 2009

(54) Lace for a shoe having a tongue and horizontal pairs of shoelace holes and for displaying a message over the tongue of the shoe and between the horizontal pairs of shoelace holes of the shoe

(76) Inventor: Rasheed Evans, Jamaica, NY (US)

Correspondence Address: CHARLES E. BAXLEY, ESQUIRE, 90 JOHN STREET, SUITE 309, NEW YORK, NY, 10038, US

(21) Appl. No.: 12/148,579

(22) Filed: Apr. 21, 2008

(51) Int. Cl. G09F 21/02

(52) U.S. Cl. 40/636

(57) ABSTRACT

A lace for a shoe having a tongue and horizontal pairs of shoelace holes and for displaying a message over the tongue of the shoe and between the horizontal pairs of shoelace holes of the shoe. The lace includes a plurality of display portions. The plurality of display portions are spaced-apart from each other and carry the message directly thereon, with each display portion carrying a specifically ordered portion of the message, thereby when the lace is threaded through the horizontal pairs of shoelace holes of the shoe, each display portion is disposed over the tongue of the shoe and between a respective horizontal pair of shoelace holes of the shoe, thereby making the message clearly visible and properly formatted.

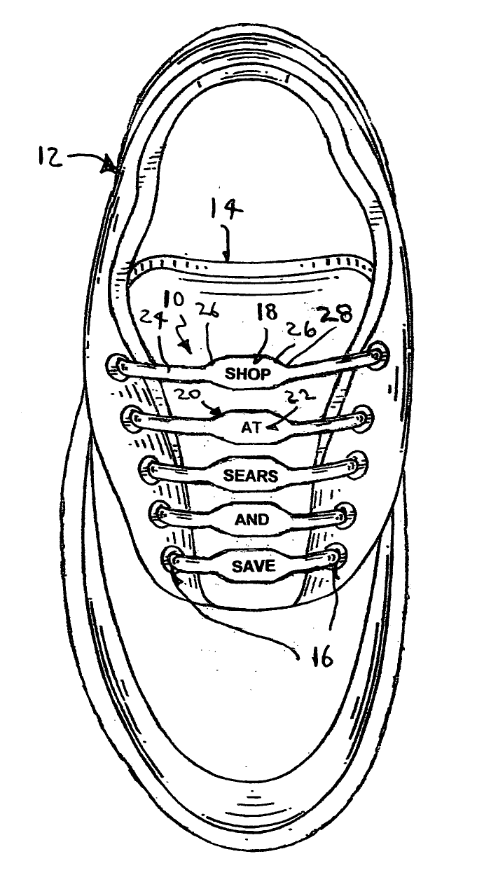

### 1: BACKGROUND OF THE INVENTION

A. Field of the Invention

The embodiments of the present invention relate to a lace for a shoe, and more particularly, the embodiments of the present invention relate to a lace for a shoe having a tongue and horizontal pairs of shoelace holes and for displaying a message over the tongue of the shoe and between the horizontal pairs of shoelace holes of the shoe.

B. Description of the Prior Art

Laces are generally used in shoes, garments, leather accessories, and other items requiring facile adjustable tying and release apparatus. Laces with fanciful decorations are typically used to enhance the appearance and aesthetic appeal of articles, such as shoes employing them. New, more decorative laces, are continually developed and successfully marketed reflecting an ever present need and demand for them.

Known shoes use shoelaces passing through or threaded through eyelets. The shoelaces are then pulled through the eyelets tightening the opening of the shoe over the tongue of the shoe, with the free ends of the laces being tied. This allows flexible adjustment of the shoe, along with securing the shoe to the wearer's foot.

Laces, in particular shoelaces, have been adorned in a variety ways as by coloration, printing of pictures and/or words thereon, inclusion of light emitting devices therein, construction with different synthetic, natural, and metallic fibers, inclusion of coils or springs therein, and the like.

Shoelaces have also be adorned with a variety of 2- and 3-dimensional objects, such as knot retainers through which shoelaces are laced to aid in maintaining shoelaces tied, and elastic shoelaces with decorative fastenings through which the shoelaces are laced.

Fixture of 3-dimensional objects, i.e., aglets, onto lace ends is also known, such as miniature bells as aglets that are affixed onto the ends of shoelaces once the laces have been laced through the eyelets of a shoe. The bells are snapped onto the shoelace ends by employing a ball and socket type configuration.

Numerous innovations for shoe lace novelties and related devices have been provided in the prior art, which will be described below in chronological order to show advancement in the art, and which is incorporated herein by reference thereto. Even though these innovations may be suitable for the specific individual purposes to which they address, however, they differ from the present invention in that they do not teach a lace for a shoe having a tongue and horizontal pairs of shoelace holes and for displaying a message over the tongue of the shoe and between the horizontal pairs of shoelace holes of the shoe.

### (1) Great Britain Patent Application Publication Number GB 200,107 to Caire et al.

Great Britain Patent Application Publication Number GB 200,107 published to Caire et al. on Jun. 30, 1923 in class A43C9 and subclass 06 teaches a boot lace tag made removable to facilitate unplacing, and preventing damage to eyelets by forming the tag in two parts. An inner tube has one end split to form resilient branches, and an outer sleeve sliding over the inner tube engages the roughened interior surface of the branches with the lace end that is inserted into the inner tube. The forward end of the inner tube is pointed, and a collar is formed on the forward end of the inner tube to serve as a stop for the sleeve.

(2) U.S. Pat. No. D400,697 to Egelja et al.

U.S. Pat. No. D400,697 issued to Egelja et al. on Nov. 10, 1998 in class D2 and subclass 969 teaches the ornamental design for a footwear upper.

(3) U.S. Pat. No. 2,646,630 to Miller.

U.S. Pat. No. 2,646,630 issued to Miller on Jul. 28, 1953 in class 35 and subclass 1 teaches an educational shoe lace for teaching children to tie a bow knot, which has indicia in the form of pictorial representations on one end portion of the lace so spaced that when the end portion is folded upon itself to bring the indicia face-to-face, a bow loop is formed. Indicia, also in the form of pictorial representations, is on the other end portion of the lace to provide a guide for threading the other end portion behind the loop to form a double bow knot. The pictorial representations are so spaced and fragmented that when the bow is properly tied, a unitary pictorial representation is attained.

(4) U.S. Pat. No. 5,158,428 to Gessner et al.

U.S. Pat. No. 5,158,428 issued to Gessner et al. on Oct. 27, 1992 in class 24 and subclass 712.9 teaches a shoelace retaining system for securing individual free ends of shoelaces after the shoelaces have been tightened on the shoe, with an engagable and disengageable retaining apparatus. The shoelace retaining apparatus has an open slot on one side allowing insertion of the shoelace along its length into the retaining portion for tightening of the shoelace by pulling the shoelace relative to the retaining device in one direction. Release of the shoelace is accomplished by pulling the shoelace outwardly through the slot and away from the retaining portions.

(5) U.S. Pat. No. 5,195,783 to Lavoie.

U.S. Pat. No. 5,195,783 issued to Lavoie on Mar. 23, 1993 in class 283 and subclass 75 teaches identification devices. Embodiments include a shoelace, near the center of which is affixed a flexible strip made from textile, plastic, or other suitable material that is adapted to be wrapped about the shoelace and retained in that position. Desired information, such as name, address, telephone number, blood type, medical facts of special concern, or the like may appear on the surface of the strip, which is to be concealed by the strip having been overlaid by itself as it is wrapped about the shoelace. The strip, so marked and so positioned, may be surrounded by a protective cover material, such as a short, tubular segment of clear plastic to protect the strip while keeping the distinguishing indicia visible. The protective cover and/or the surface of the strip, which is exposed when the strip is so wrapped, may include distinguishing indicia to notify interested persons, such as police, medical workers, etc. of the existence of the enclosed information. Thereby the identification of a lost child or information relevant to treating a person in medical emergency may be identified as being available and made accessible when needed, while being concealed until then.

(6) U.S. Pat. No. 6,112,380 to Dolan et al.

U.S. Pat. No. 6,112,380 issued to Dolan et al. on Sep. 5, 2000 in class 24 and subclass 715.4 teaches laces, such as shoelaces having affixed thereto repeatedly collapsible and expandable aglets forming 2- or 3-dimensional objects. The aglets are passed through an eyelet, thereby making it possible for them to be permanently affixed to laces during their manufacture. Thus, a user need not purchase a lace and aglets separately and attach them to each other after lacing an article, such as a shoe.

(7) U.S. Pat. No. 6,434,870 to Fanjoy.

U.S. Pat. No. 6,434,870 issued to Fanjoy on Aug. 20, 2002 in class 40 and subclass 636 teaches a personalized message tag attached to the laces of a shoe, bearing on the front visible surface the introductory portion of a desired phrase and having a non-visible rear surface that the wearer can inscribe a completing portion the desired phrase. The tags are provided with a discrete color for each separate introductory portion 24 of the desired phrase.

### (8) United States Patent Application Publication Number 2005/0217089 to Lin.

United States Patent Application Publication Number 2005/0217089 published to Lin on Oct. 6, 2005 in class 24 and subclass 712 teaches a shoelace structure made up of a belt-like shoelace having two narrowed leading ends bound at both ends thereon to be led through buttonholes of a shoe body, thereby wherein between both narrowed leading ends thereof are disposed a tying section to be tied up at the upper surface of the shoe body thereof and a passage section to be wound through the buttonholes of the shoe body thereby. Both the tying section and the passage section are integrally woven to form a plurality of bulge parts and narrowed parts that are alternatively arranged with each adjacent to others in a sequence. The bulge parts of the tying section and the passage section thereof can be made into a wide flatness or a protruded arc shape thereof, and the narrowed parts thereof can be formed into a straight flatness or a round straight column thereof. Thus, the tying section and the passage section of the shoe body are contacted with a tying spot and the buttonholes, respectively, by the narrowed parts thereof, and retained in place by the bulge parts limiting at both adjacent sides of the narrowed parts thereof so as to efficiently prevent the shoelace from getting loose and detached in practical use.

It is apparent that numerous innovations for shoe lace novelties and related devices have been provided in the prior art that are adapted to be used. Furthermore, even though these innovations may be suitable for the specific individual purposes to which they address, however, they would not be suitable for the purposes of the embodiments of the present invention as heretofore described, namely, a lace for a shoe having a tongue and horizontal pairs of shoelace holes and for displaying a message over the tongue of the shoe and between the horizontal pairs of shoelace holes of the shoe.

### 2. SUMMARY OF THE INVENTION

Thus, an object of the embodiments of the present invention is to provide a lace for a shoe having a tongue and horizontal pairs of shoelace holes and for displaying a message over the tongue of the shoe and between the horizontal pairs of shoelace holes of the shoe, which avoids the disadvantages of the prior art.

Briefly stated, another object of the embodiments of the present invention is to provide a lace for a shoe having a tongue and horizontal pairs of shoelace holes and for displaying a message over the tongue of the shoe and between the horizontal pairs of shoelace holes of the shoe. The lace includes a plurality of display portions. The plurality of display portions are spaced-apart from each other and carry the message directly thereon, with each display portion carrying a specifically ordered portion of the message, thereby when the lace is threaded through the horizontal pairs of shoelace holes of the shoe, each display portion is disposed over the tongue of the shoe and between a respective horizontal pair of shoelace holes of the shoe, thereby making the message clearly visible and properly formatted.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The sole FIGURE of the drawing is a diagrammatic top plan view of the lace of the embodiments of the present invention for a shoe having a tongue and horizontal pairs of shoelace holes and displaying a message over the tongue of the shoe and between the horizontal pairs of shoelace holes of the shoe.

### 4. LIST OF REFERENCE NUMERALS UTILIZED IN THE DRAWING

### A. General.

10 lace of embodiments of present invention for shoe 12 having tongue 14 and horizontal pairs of shoelace holes 16 and for displaying message 18 over tongue 14 of shoe 12 and between horizontal pairs of shoelace holes 16 of shoe 12
12 shoe
14 tongue of shoe 12
16 horizontal pairs of shoelace holes of shoe 12
18 message

### B. Configuration of Lace 10.

20 plurality of display portions
22 specifically ordered portion of message 18
24 plurality of intermediate portions
26 sides of each display portion of plurality of display portions 20
28 filets

### 5. DETAILED DESCRIPTION OF THE PREFERRED EMBODIMENTS

### A. General.

Referring now to the sole FIGURE, which is a diagrammatic top plan view of the lace of the embodiments of the present invention for a shoe having a tongue and horizontal pairs of shoelace holes and displaying a message over the tongue of the shoe and between the horizontal pairs of shoelace holes of the shoe, the lace of the embodiments of the present invention is shown generally at 10 for a shoe 12 having a tongue 14 and horizontal pairs of shoelace holes 16 and for displaying a message 18 over the tongue 14 of the shoe 12 and between the horizontal pairs of shoelace holes 16 of the shoe 12.

### B. The Configuration of the Lace 10.

The lace 10 comprises a plurality of display portions 20. The plurality of display portions 20 are spaced-apart from each other and carry the message 18 directly thereon, with each display portion 20 carrying a specifically ordered portion 22 of the message 18, thereby when the lace 10 is threaded through the horizontal pairs of shoelace holes 16 of the shoe 12, each display portion 20 is disposed over the tongue 14 of the shoe 12 and between a respective horizontal pair of shoelace holes 16 of the shoe 12, thereby making the message 18 clearly visible and properly formatted.

Each display portion 20 is flat so as to readily display an associated specifically ordered portion 22 of the message 18.

The plurality of display portions 20 are spaced-apart from each other by a plurality of intermediate portions 24, respectively. Each display portion 20 has sides 26 tapering into adjacent intermediate portions 24 to form filets 28 to maintain structural integrity between the plurality of display portions 20 and the plurality of intermediate portions 24.

### C. The Conclusions.

It will be understood that each of the elements described above or two or more together may also find a useful application in other types of constructions differing from the types described above.

While the embodiments of the present invention have been illustrated and described as embodied in a lace for a shoe having a tongue and horizontal pairs of shoelace holes and for displaying a message over the tongue of the shoe and between the horizontal pairs of shoelace holes of the shoe, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A lace for a shoe having a tongue and horizontal pairs of shoelace holes and for displaying a message over the tongue of the shoe and between the horizontal pairs of shoelace holes of the shoe, comprising:
a plurality of display portions;
wherein said plurality of display portions are spaced-apart from each other and carry said message directly thereon, with each display portion carrying a specifically ordered portion of said message, thereby when said lace is threaded through the horizontal pairs of shoelace holes in the shoe, each display portion is disposed over the tongue of the shoe and between a respective horizontal pair of shoelace holes of the shoe, thereby making said message clearly visible and properly formatted.

2. The lace of claim 1, wherein each display portion is flat so as to readily display an associated specifically ordered portion of said message.

3. The lace of claim 1, wherein said plurality of display portions are spaced-apart from each other by a plurality of intermediate portions, respectively.

4. The lace of claim 3, wherein each display portion has sides; and
wherein said sides of each display portion taper into adjacent intermediate portions to form filets to maintain structural integrity between said plurality of display portions and said plurality of intermediate portions.
